(19) United States
(12) Patent Application Publication
(10) Pub. No.: US 2015/0299343 A1
(43) Pub. Date: Oct. 22, 2015

(54) POLYMER PLASTICIZING AGENTS THAT PRODUCE POLYMERS THAT DO NOT RELEASE ENDOCRINE DISRUPTING COMPOUNDS

(71) Applicant: THE REGENTS OF THE UNIVERSITY OF CALIFORNIA, Oakland, CA (US)

(72) Inventor: Rebecca Braslau, Santa Cruz, CA (US)

(73) Assignee: The Regents of the University of California, Oakland, CA (US)

(21) Appl. No.: 14/440,840

(22) PCT Filed: Nov. 5, 2013
(86) PCT No.: PCT/US13/68410

§ 371 Date: May 5, 2015

Related U.S. Application Data
(60) Provisional application No. 61/722,346, filed on Nov. 5, 2012.
(60) Provisional application No. 61/729,717, filed on Nov. 26, 2012.
(60) Provisional application No. 61/880,964, filed on Sep. 22, 2013.

(51) Int. Cl. C08F 8/30; C08L 25/18; C08L 27/22

(52) U.S. Cl. CPC C08F 8/30; C08L 27/22; C08L 25/18

(57) ABSTRACT

Disclosed are novel phthalate compounds and a simple and economical route to covalently attach a phthalate ester mimic to PVC is described, allowing plasticization of PVC without the danger of Endocrine Disruption Chemicals leaching from the polymer matrix. An azide-alkyne Husigen cycloaddition (in the absences of copper catalyst) using dialkyl acetylenedicarboxylates allows this cycloaddition to occur under very mild thermal conditions.

### RELATED APPLICATIONS

This application claims priority to and the benefit of U.S. provisional application No. 61/594,052 filed on 2 Feb. 2012; 61/722,346 filed 5 Nov. 2012; and 61/729,717 filed 26 Nov. 2012. The only inventor on all these applications is Dr. Rebecca Braslau. All three of these applications (and all cited literature and publications herein) are incorporated by reference for all purposes.

### STATEMENT OF SUPPORT

This invention was made with support of the following: None.

### FIELD OF THE INVENTION

Plasticizing agents used for changing the physical qualities of commercial polymers.

### BACKGROUND

Plasticizers are compounds added to a material to decrease brittleness and increase the plasticity or fluidity of the material. The most common applications are for plastics, especially polyvinyl chloride (PVC). Traditional Plasticizers work by embedding themselves between chains of polymers, with no covalent bonds being formed, thereby spacing the polymer chains apart and increasing the “free volume”, thus lowering the glass transition temperature for the plastic and making it softer.

Phthalates (also called phthalate esters) are esters of phthalic acid (1,2-benzenedicarboxylic acid) and are mainly used as plasticizers. Plasticizers are compounds that are added to plastics to alter their flexibility, transparency, durability, stiffness and longevity, frequently increasing plastic qualities such as malleability and decreasing brittleness. They are primarily used to soften polyvinyl chloride (PVC) with almost 90% of the market for plasticizers being used for PVC, providing improved flexibility and durability.

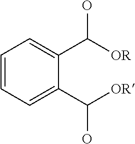

Shown above is a generic chemical structure of a phthalate. R and R′═CₙH₂ₙ₊₁; n=4-15.

Since the 1930's small molecule phthalate esters have been used very commonly (approx. 6 million tons per year) for the formulation of PVC consumer products. Phthalates are relativly easily leached from the plastic matrix into the environment due to the fact that there is no covalent bond between the phthalates and plastics in which they are mixed. As plastics age and break down, the rate of release of phthalates accelerates.

In use, phthalate esters leach from the polymer matrix, and when metabolized, can give rise to molecules that can bind to and act upon endocrine receptors for mammals, reptiles, amphibians and bird. This is because the leached phthalate esters can structurally and functionally resemble hormones, and therefore act as endocrine disruptors.

These endocrine disruptors are implicated in a variety of serious health problems including male and female reproductive tract abnormalities, and feminization, miscarriage, menstrual problems, changes in hormone levels, early puberty, brain and behavior problems, impaired immune functions, developmental abnormalities, infertility and cancer. These dangers have been recognized and phthalate plasticizers have been banned from a number of specific applications including child care products and some toys. The use of the specific phthalate esters DEHP, DBP (dibutyl phthalate) and BBP (butylbenzyl phthalate) in toys and other child care articles was forbidden by the European Union in 2005, and was banned by the Consumer Safety Commission in 2009 in the United States for toys marketed to children younger than 12 years old, and child care articles for children up to age 3. But phthalate plasticizers continue to be used for food packaging, medical devices and some toys, and also in articles such as rain coats and cosmetics. Clearly there is a need for alternative plasticizers that do not pose such risks.

### BRIEF DESCRIPTION OF THE INVENTION

The invention encompasses a novel, simple and economical method of covalently attaching a phthalate ester mimic to polymers such as PVC, allowing plasticization of PVC and other polymers to produce commercial polymers from which endocrine disruption chemicals do not leach (or leach in very small quantities) from the polymer matrix. The invention also encompasses the products of such methods, as well as methods for making and using such compounds and plastics (such as PVC) blended with such compounds.

### BRIEF DESCRIPTION OF THE FIGURES

See figures in the text

General Representations Concerning the Disclosure

All disclosures, publications and patent documents disclosed herein are hereby incorporated by reference to the fullest extent allowed by law. Other publications specifically incorporated by reference include: Navarro et al. ‘Phthalate Plasticizers Covalently Bound to PVC: Plasticization with Suppressed Migration.’ Macromolecules 2010, 43, 2377-2381; and Pawlak et al. ‘Ferrocene Bound Poly(vinyl chloride) as Ion to Electron Transducer in Electrochemical Ion Sensors.’ Analytical Chemistry 2010, 82 (16) 6887-6894; and Pawlak et al. ‘In situ surface functionalization of plasticized poly(vinyl chloride) membranes by ‘click chemistry’.’ Journal of Materials Chemistry 2012, 22 (25), 12796-12801; and Gonzaga et al. ‘Versatile, efficient derivatization of polysiloxanes via click technology.’ Chemical Communications 2009, (13) 1730-1732; and Grande et al. ‘Testing the functional tolerance of the Piers-Rubinsztajn reaction: a new strategy for functional silicones.’ Chemical Communications 2010, 46 (27), 4988-4990.

The embodiments disclosed in this specification are exemplary and do not limit the invention. Other embodiments can be utilized and changes can be made. As used in this specification, the singular forms “a”, “an”, and “the” include plural reference unless the context clearly dictates otherwise. Thus, for example, a reference to “a part” includes a plurality of such parts, and so forth. The term “comprises” and grammatical equivalents thereof are used in this specification to mean that, in addition to the features specifically identified, other features are optionally present. Where reference is made in this specification to a method comprising two or more defined steps, the defined steps can be carried out in any order or simultaneously (except where the context excludes that possibility), and the method can optionally include one or more other steps which are carried out before any of the defined steps, between two of the defined steps, or after all the defined steps (except where the context excludes that possibility). Where reference is made herein to “first” and “second” features, this is generally done for identification purposes; unless the context requires otherwise, the first and second features can be the same or different, and reference to a first feature does not mean that a second feature is necessarily present (though it may be present). Where reference is made herein to “a” or “an” feature, this includes the possibility that there are two or more such features. This specification incorporates by reference all documents referred to herein and all documents filed concurrently with this specification or filed previously in connection with this application, including but not limited to such documents which are open to public inspection with this specification.

### DEFINITIONS

The following words are used herein as follows:
The word Plasticizer is used herein to describe any substance added to a polymer to change brittleness, plasticity, viscosity, fluidity, hardness or alter another physical quality of the polymer.
The word Plastic refers to any polymeric organic amorphous solid compound that is moldable when heated and includes, for example acrylics, polyesters, silicones, polyurethanes, and halogenated plastics.
The word Hormone is used herein to describe any compound that interacts with the endocrine system of an animal.
The term Endocrine disruptor is used herein to describe any compound that interferes with the normal physiological functioning of the endocrine system of an animal.
To say that a plasticizer does not release phthalate esters, in this disclosure, means that it does not release an appreciable amount of phthalate esters, or alternatively that it releases less than the amount of phthalate esters that a commonly used traditional plasticizer will release over the same period of time; for example no more than 10% or 20%. In other embodiments it may release no more than 30%, 40%, 50%, 60%, 70% or no more than 80% of phthalate esters that a commonly used traditional plasticizer will release over the same period of time. For example a plasticizer made of short polymers consisting of a covalent carbon chain backbone bearing phthalate ester side-groups may release less than 30% of the phthalate esters that would be released by a plasticizer not made of short polymers consisting of a covalent carbon chain backbone bearing phthalate ester side-groups.
A “click” reaction is a Cu-assisted azide-alkyne cycloaddition.

### DETAILED DESCRIPTION OF THE INVENTION

The invention encompasses a novel, simple and economical method of covalently attaching a phthalate ester mimic to polymers such as PVC, allowing plasticization of PVC and other polymers to produce commercial polymers from which endocrine disruption chemicals do not leach (or leach in very small quantities) from the polymer matrix. The invention also encompasses the products of such reactions and methods for making and using such compounds and plastics (such as PVC) blended with such compounds. Plastics and polymers that may be plasticized by the method of the invention include, for example, polyvinyl chloride, polyvinyl acetate, rubbers, cellulose plastics, and polyurethane.

In the method of the invention, an azide-alkyne Husigen cycloaddition using dialkyl acetylenedicarboxylates allows cycloaddition to occur under very mild thermal conditions, such as room temperature, such as between 10° C. and 20° C., for example below 40° C., below 30° C., below 20° C., below 15° C., or below 10° C. In certain embodiments the method is carried out in the absence of a catalyst, for example in the absence of a metal catalyst, for example in the absence of a copper catalyst.

A novel, simple and economical route to covalently attach a phthalate ester mimic to PVC is described, allowing plasticization of PVC without the danger of Endocrine Disruption Chemicals leaching from the polymer matrix. An azide-alkyne Husigen cycloaddition (in the absence of a metal catalyst, e.g., a copper catalyst) using dialkyl acetylenedicarboxylates allows cycloaddition to occur under very mild thermal conditions.

In most embodiments, the azide-alkyne Huisgen cycloaddition is Cu free and performed at low temperatures, e.g., below 20° C. or 10° C., but I other embodiments the reaction is carried out using a catalyst, such as using a metal catalyst such as Cu, and may (separately or in addition) be carried out at higher temperatures, for example between 20° C. and 60° C., for example above 10° C., above 20° C., above 30° C., above 40° C., or above 50° C.

The method of the invention may be performed by the chemical modification of already formed polymers such as polyvinyl chloride, or in other embodiments, may be performed by the modification of monomers prior to polymerization by the cycloaddition of dialkyl acetylenedicarboxylates.

In most embodiments, allylic sites on a polymer or monomer (to be polymerized) may be targets for azide displacement. Allylic C—H bonds are about 15% weaker than the normal C—H bonds and the most labile electrophilic chloride sites on PVC are secondary allylic chlorides. However, in other embodiments, particularly with PVC or other polymers that do not have many allylic sites, regular alkyl secondary chlorides can be displaced by azide as well as allylic chlorides.

An important embodiment of the invention is the discovery of a method for the production of covalently-bonded mimics of phthalate plasticizers, the method comprising performing an azide-alkyne Huisgen cycloaddition reaction of dialkyl acetylenedicarboxylates with azide-functionalized PVC.

In some embodiments the method of thermal azide-alkyne Husigen cycloaddition may be performed in the absence of a copper catalyst. The methods may be performed without any external catalyst, for example without a metal catalyst, for example without a copper catalyst. In some embodiments the method of thermal azide-alkyne Husigen cycloaddition may be performed under very mild thermal conditions.

In some embodiments the method may be performed wherein the thermal conditions are ambient conditions (room temperature) and the time of reaction is extended. For example, the thermal conditions of the reaction may be between 5° C. and 35° C., between 10° C. and 30° C., between 15° C. and 25° C. In other embodiments the thermal conditions of the reaction may be between 10° C. and 100° C., 30° C. and 75° C., 25° C. and 60° C., 10° C. and 20° C., or simply at room temperature. Alternatively the temperature at which the reaction is performed bay be below 40° C., below 30° C., below 20° C., below 15° C., or below 10° C.

In some embodiments the reaction requires at least 4 hours to proceed to at least 80% completion. In others it requires at least 6 hours to proceed to at least 95% completion. In other embodiments, to reach 90% completion, the reaction may require, 2, 4, 6, 8, 10, 12, 14, 16, 18, 20, 22, or 24 hours or may simply be performed overnight.

The invention encompasses polymers (e.g., for example, polyvinyl chloride, polyvinyl acetate, rubbers, cellulose plastics, and polyurethane) to which a phthalate ester mimic is covalently attached, allowing plasticization of polymers such as PVC without the danger of Endocrine Disruption Chemicals leaching from the polymer matrix.

The invention includes products-by-process comprising a polymer plasticized by the method of the invention.

An azide-alkyne Husigen cycloaddition in the absence of a metal (e.g., copper) catalyst using dialkyl acetylenedicarboxylates allows this cycloaddition to occur under very mild thermal conditions.

Azide-alkyne Huisgen 1,3-dipolar cycloaddition reactions utilizing very electron deficient acetylenes with alkyl azides can take place at room temperature in the absence of a metal catalyst. Electron-poor alkynes bearing esters, carboxylic acids, amides and sulfones used in Cu-free “click” cycloadditions at ambient temperature are suitable for widespread use in organic synthesis, biomolecular investigations and the development of new materials.

A particular example focuses on polyvinyl chloride. The problem of leaching of endocrine disrupters from plasticized compounds is solved by the formation of covalently-bound 1,2,3-Triazole Phthalate Mimics. Treatment with sodium azide produces PVC in which some of the chloride has been replaced with azide. Reaction with dialkyl acetylene-dicarboxylates will give 1,2,3-triazoles bearing ortho esters. Esters made of branched alcohols form mimics of phthalate ester plasticizers, covalently linked to PVC. Migration of these plasticizer mimics is completely suppressed; hydrolysis will release only alcohols rather than phthalates. These triazoles bearing branched esters prove to be effective plasticizers and this approach may be used to replace the use of millions of tons of phthalate esters produced every year as plasticizers.

Additional embodiments of the invention include further monomers beyond vinyl bearing 1,2,3-Triazole Phthalate Mimics prepared by Azide/Alkyne Cycloaddition. Whereas the original invention encompassed a vinyl monomer that can be modified to bear a phthalate mimic consisting of a triazole:

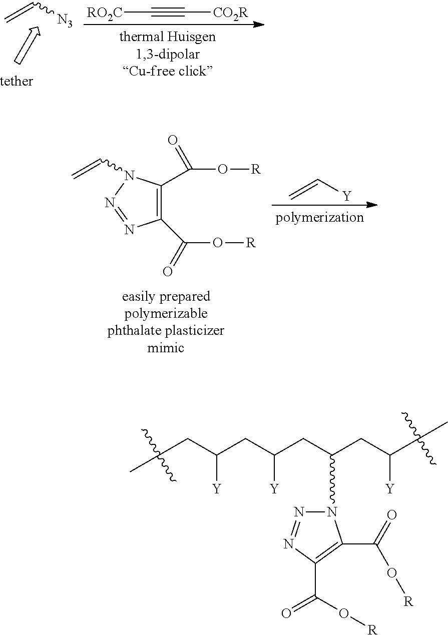

Alternative embodiments may expand this to the use of vinyl precursors, that undergo the dipolar cycloaddition prior to formation of the vinyl group:

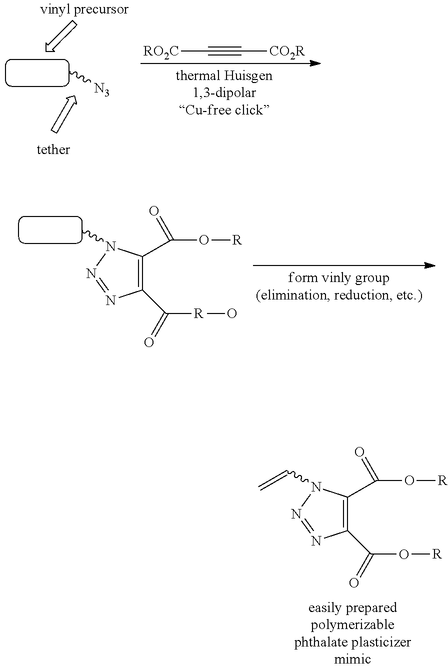

An example of this is following sequence: triazole formation followed by elimination (upon treatment with base, heat, or other stimulus) to form the vinyl moiety:

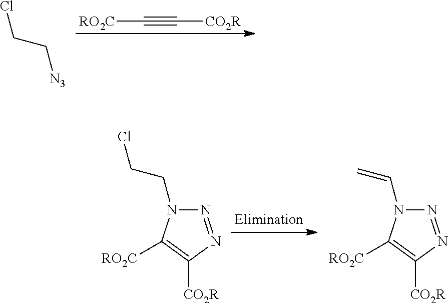

Vinyl azide is produced by a similar reaction, and provides an alternative route.

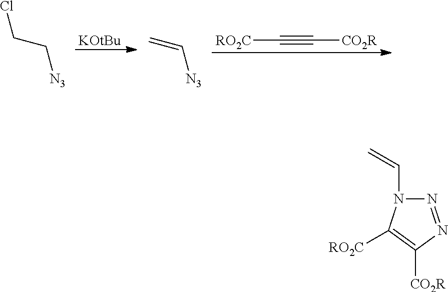

In the basic embodiment, vinyl acetate analogues are used as a typical monomer class. In other embodiments, this is expanded to include vinyl ethers, to provide electron rich monomers that are easily copolymerized with vinyl chloride:

| vinyl acetate analogues | vinyl ethers |
|---|---|
| 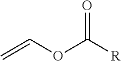 | 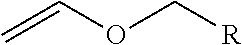 |
| 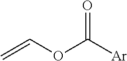 | 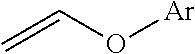 |

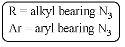

For example, the widely available vinyl chloroacetate can be converted to the azide and then the triazole:

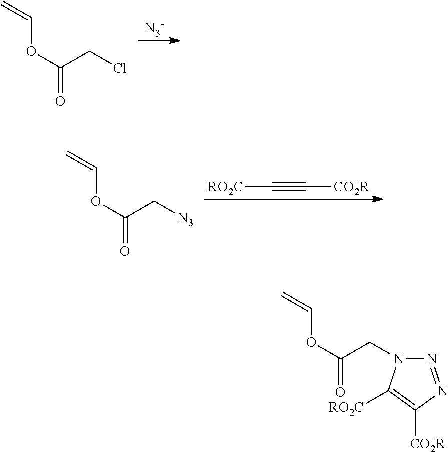

and the commodity chemical 2-chloroethyl vinyl ether can be converted into the azide and then the triazole:

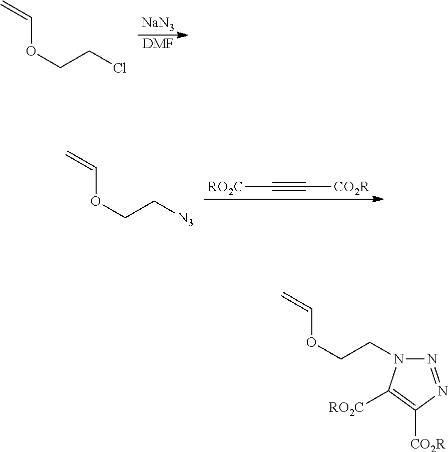

These electron-rich alkenes can undergo copolymerization in an uncontrolled fashion (as a bulk solution, dispersion, inversion dispersion, emulsion, etc.) or in a controlled polymerization with vinyl acetate to give PVC with covalently attached phthalate mimics.

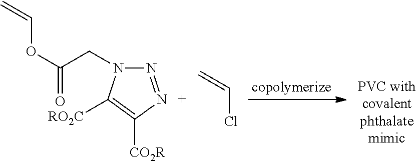

Likewise, the copolymerization of vinyl chloride with vinyl ethers will also generate covalently attached phthalate mimics.

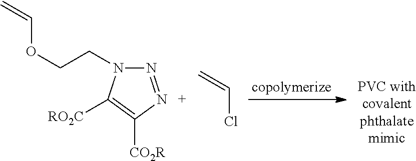

Another embodiment encompasses the use of olefin monomers. A thermal azide-alkyne Huisgen cycloaddition (preferably in the absences of copper catalyst) using dialkyl acetylene-dicarboxylates allows cycloaddition to be carried out on olefin monomers bearing azides under very mild thermal conditions. Olefin monomers may be, for example, acrylates, acrylamides, methacrylates, styrenes, vinyl acetate (and derivatives, such as alpha-chlorovinyl acetate), vinyl chloride, dienes, acrylonitrile, maleimides, norbornenes, vinyl ethers, fumarates, vinyl ketones, 1-alkenes, or maleic anhydrides.

In another alternative embodiment of the Cu-free “click” cycloadditions, the order of “click” reaction may be changed, and rather than having olefin monomers functionalized by azide, and then clicked, an alternative method is to functionalize with azide, click, and then form the olefin group.

In various embodiments vinyl chlorides may be used as monomers, but other monomers may be used, for example vinyl ethers and vinyl acetates. This is a useful embodiment since copolymerization of the electron-rich olefin monomers with vinyl chloride should be particularly effective.

A further embodiment provides monomers bearing 1,2,3-triazole phthalate mimics prepared by azide/alkyne cycloaddition. The method encompasses formation of monomers bearing phthalate ester mimics, which can be used in a variety of polymerization reactions to incorporate covalently bonded plasticizers into polymer chains. A simple thermal reaction at or near room temperature in the absence of catalyst is used to prepare the polymerizable monomers from readily available starting materials. A variety of olefin monomers are envisioned. A Huisgen 1,3-dipolar cycloaddition of azide and alkynes is utilized to prepare 1,2,3-triazoles bearing ortho esters containing branched alkoxy groups, to create mimics of phthalate esters into monomers, which upon polymerization will result in plasticizer mimics covalently incorporated into a variety of polymers. hydrolysis will release only alcohols rather than phthalates. The azide group is easily introduced into molecules by SN2 reaction. The azide group cannot be carried through free radical polymerization, as carbon radicals add to azides. However, 1,3-dipolar cycloaddition with dialkyl acetylenedicarboxylates will provide aromatic triazole products, which will be completely compatible with free radical polymerization reactions. To date, several azide-containing polymers have been utilized: Cu catalyzed “click” cycloaddition is carried out prior (or concurrently) to their use as monomers. The styrene derivative benzyl azide 18 (3) has been utilized in ATRP radical polymerizations, with concurrent Cu-catalyzed “click” cycloaddition. Multiple references 19 to methacrylates (4) have been reported, to make triazole-containing comonomers, which are then used in ATRP or RAFT radical polymerizations. In one case, the azide monomer (4) (n=2) was successfully utilized in both ATRP and RAFT polymerizations at 60° C. and 65° C., to form azide-functionalized polymers, followed by reactions of the pendant azides to prepare specialized surface coatings. Methacrylate (5) bearing an aryl azide ester (21) has been utilized in Cu catalyzed click chemistry followed by RAFT polymerization. Methacrylamide has been utilized in Cu-catalyzed click reactions followed by both ATRP22 and RAFT23 polymerizations. Azide-containing monomers will be converted under mild, Cu-free conditions to the corresponding triazoles, for subsequent use in random copolymerizations. For example, benzyl azide 3 will be converted to the triazole styrene 7, which can be used to covalently incorporate covalently bonded plasticizers as random copolymers. In a second example, acrylate or methacrylates are converted to triazoles (8) for subsequent use as monomeric polymerizable plasticizers. Another easily accessed acrylate or methacrylate is the azide 9 obtained by azide opening of the epoxide 24 of glycidyl acrylate or glycidyl methacrylate. This general approach can be envisioned to prepare monomeric derivatives of styrenes, acrylates and methacrylates, acrylamides and methacrylamides, maleimides and even vinyl acetate analogues, as shown in the Table 1.

TABLE 1
Common Olefin Monomer Classes Amenable to triazole attachment

| styrenes | acrylates, methacrylates | acrylamides, methacrylamides | | maleimides | vinyl acetate analogues |
|---|---|---|---|---|---|
| 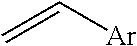 | 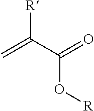 | 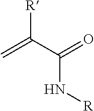 | 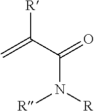 | 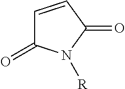 | 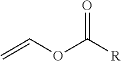 |
| | 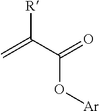 | 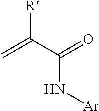 | 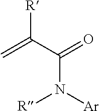 | 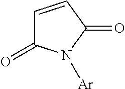 | 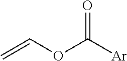 |

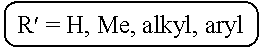

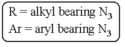

In order to mimic a number of different phthalate ester plasticizers, the alcohol on the ester moieties of the triazole can be varied.

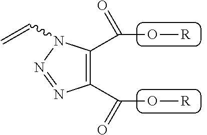

| | phthalate |
|---|---|
| | being |
| Alcohol | mimicked |
| 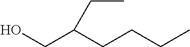 | DEHP |
| 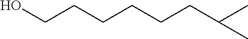 | DINP |
| 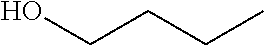 | DBP |
| 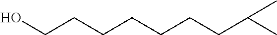 | DIDP |
| 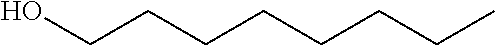 | DOP |
| 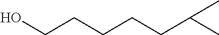 | DIOP |
| 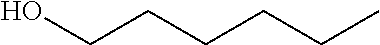 | DNHP |
| 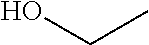 | DEP |
| 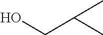 | DIBP |
| 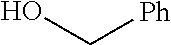 | (half of) BBzP |

Materials and Methods

The present method employing a mild “click” approach to phthalate ester mimics is a simple, economical and scalable alternative to the use of phthalate plasticizers, while mitigating the health hazards associated with the use of phthalates.

The powerful Huisgen 1,3-dipolar cycloaddition of azide and alkynes is utilized to prepare 1,2,3-triazoles bearing ortho esters containing branched alkoxy groups, to prepare mimics of phthalate esters covalently linked to PVC. Thus migration is completely suppressed; hydrolysis will release only alcohols rather than phthalates. Thus degradation products pose no danger of being metabolized to form Endocrine Disruptor Compounds.

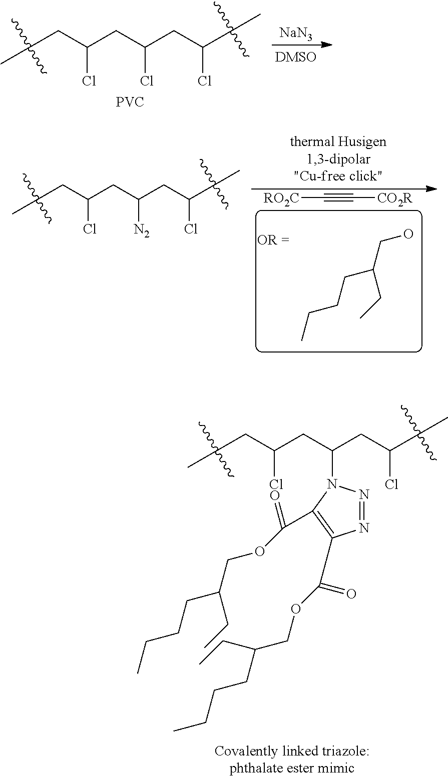

Azide is a fairly good nucleophile. The polarity of the solvent, temperature, reaction time and stoichiometry of azide utilized is critical in controlling the amount of SN2 substitution reaction compared to elimination. DMF is usually the solvent of choice, however use of the less polar solvent cyclohexanone results in a slower reaction, allowing stereoselective displacement to occur at the mm triad of mmmr tetrads, and the rm diad of rrmr pentads. Surface modification by azide displacement of chloride has also been studied on PVC films.

Cu-assisted azide-alkyne cycloaddition (commonly known as a “click” reaction) has become an extremely popular method to reliably form triazoles from organoazides and terminal alkynes. Bakker has utilized Cu-catalyzed “click” chemistry to surface functionalize PVC bearing azide groups with ferrocene and fluorescent dyes using terminal alkynes, with the goal of tuning the electronic properties of the membrane solution interface of ion sensors. However, the use of a copper catalyst, even in trace amounts, is not desirable for a commodity product with applications in the construction of medical devices and food and drink packaging. Copper free variations utilizing cyclooctynes have enjoyed popularity in both biology and materials science, but is restricted to the use of very specialized 8-membered ring cyclic alkynes. By utilizing alkynes substituted on both ends by an ester, the alkyne partner becomes extremely electrophilic, lowering the LUMO, and thus enhancing the 1,3-dipolar cycloaddition. For example, Brimble utilized dimethyl acetylenedicarboxylate to carry out thermal Huisgen cycloaddition in neat excess alkyne at 100° C. to form triazole (6). In a second example, Brook has carried out thermal Huisgen 1,3-dipolar cycloaddition with dialkyl acetylenedicarboxylates with diazide-terminated siloxanes such as (7). Another advantage of utilizing dialkyl acetylenedicarboxylates is that the alkyne is symmetrical, thus avoiding mixtures of regioisomers often observed in thermal Huisgen cycloadditions.

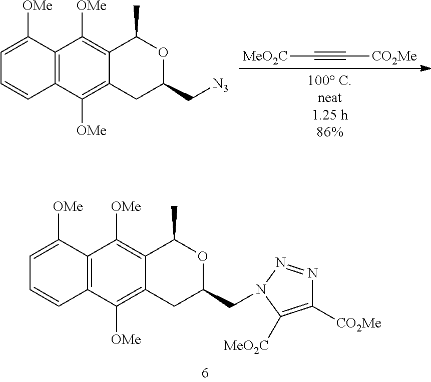 [SMILES: COc1c2c(c(OC)c3c(OC)cccc13)[C@@H](C)O[C@@H](CN=[N+]=[N-])C2 ; COC(=O)C#CC(=O)OC ; COC(=O)c1nnn(C[C@H]2Cc3c(c(OC)c4c(OC)cccc4c3OC)[C@@H](C)O2)c1C(=O)OC]

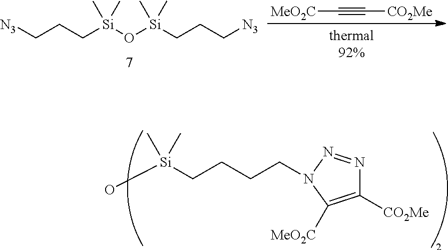

Results

Given that dehydrochlorination of HCl from PVC occurs thermally by multiple mechanisms, azide substitution in polar solvents is likely to occur at allylic chlorides by an SN2′ mechanism prior to SN2 at secondary alkyl chlorides. Thus the most labile electrophilic chloride sites on PVC are secondary allylic chlorides.

As a small molecule model, the inventors utilized the secondary benzylic chloride 1-chloro-1-phenylethane (8): azide displacement of chloride using NaN3 on Amberlite resin was straightforward.

The researchers then carried out the key thermal Huisgen 1,3-dipolar cycloaddition (in the absence of Cu) to form triazole (9); the results are summarized in the Table. The reaction was monitored by both TLC and 1H-NMR. Following the general procedure of Brimble, the researchers started out with a large excess of the electron poor dimethyl acetylenedicarboxylate at 100° C.: the reaction went to completion in under an hour. The researchers then reduced the number of equivalents as well as the temperature.

The researchers were excited to find that the reaction goes to completion with only a slight excess of alkyne, and the temperature can be reduced to ambient conditions (room temperature), albeit requiring an overnight reaction time. The reaction proceeds equally well neat, or with deuterochloroform as the solvent.

As a second model, the researchers also converted geranyl chloride (a primary allylic chloride) to the azide. Cu-free “click” reaction with dimethyl acetylenedicarboxylate gave complete conversion to the triazole at room temperature overnight, isolated in 83% yield.

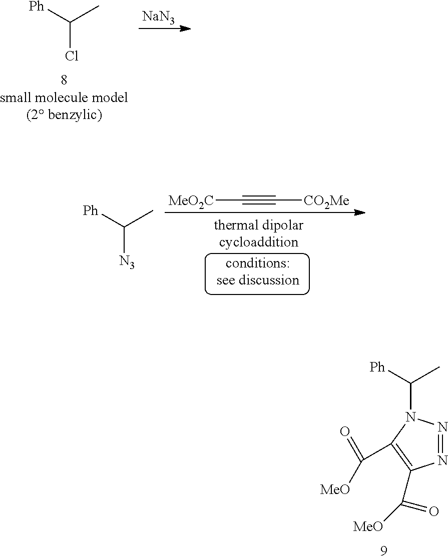

| Equivalents | | | |
|---|---|---|---|
| of dimethyl | | | |
| acetylenedi- | | | |
| carboxylate | Solvent | Temperature | Tme |
| 5\|0 | neat | 100° C. | 40 min |
| 5 | neat | 50° C. | 40 min |
| 5 | neat | RT | 40 min |
| 1.5 | neat | RT | overnight |
| 1.5 | CDCl₃ | RT | overnight |

The next step is performing an azidization of PVC: this reaction is usually monitored by IR. Bakker has determined reaction times for azide displacement of chloride in commercial PVC (purchased from Sigma-Aldrich) to obtain 2-6% azidification. In addition, 1H-NMR and elemental analysis will provide additional tools to determine conversion.

The key thermal cycloaddition between dialkyl acetylenedicarboxylates is carried out in solution, followed by precipitation of the polymer (typically PVC is dissolved in THF, and precipitated by addition of methanol, however use of 1,2-dichlorobenzene as solvent followed by addition of toluene has also been used).

The researchers chose dimethyl acetylenedicarboxylate for our initial experiments, to generate simple NMR spectra. The cycloaddition described may be extended to PVCazide, branched alkyl esters related to the most common phthalate esters.

| | phthalate |
|---|---|
| | being |
| Alcohol | mimicked |
| 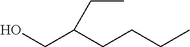 | DEHP |
| 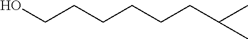 | DINP |
| 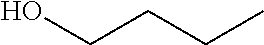 | DBP |
| 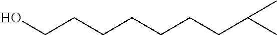 | DIDP |
| 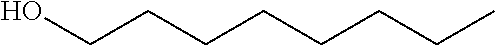 | DOP |
| 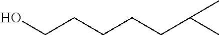 | DIOP |
| 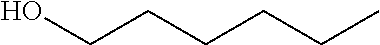 | DNHP |
| 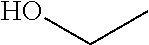 | DEP |
| 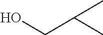 | DIBP |
| 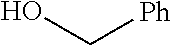 | (half of) BBzP |

Characterization of the Modified PVC Polymers and their Plasticizing Properties

The characterization of the polymers with covalently linked triazoles uses IR, 1H NMR spectroscopy and GPC (size exclusion chromatography) for determination of percent conversion, molecular weight, and polydispersity. Modified polymers are analyzed for miscibility and homogeneity over time, as well as chemical stability and resistance to migration as follows:

Miscibility (measured by IR) of the derivatized PVC with untreated PVC may be determined by IR spectroscopy.

Miscibility (measured by DSC): the existence of a single glass transition temperature determined by differential scanning calorimetry (DSC) for a polymer blend is the least ambiguous evidence for miscibility. For the most promising samples, additional information regarding miscibility and morphology may be be obtained using scanning electron microscopy (SEM).

Plasticization as measured by depressed glass transition temperatures: the plasticizing properties of the new polymer blends may be be probed by measuring the glass transition (Tg) temperature, the depression of which is a reliable quantitative measure of the increased flexibility, or softening of the polymer blend.

Stability and migration resistance of covalent plasticizer mimics and their possible degradation products: Hydrolysis of modified PVC films may be performed by aging the films for 10 weeks at 37° C., and at 70° C. in water at neutral and low pH following ASTM methods for extractability in hexanes and methanol. The degradation products can be analyzed by GC-MS. Mass loss and water absorption of the films can also be measured.

Long-term homogeneity of the PVC/polymeric plasticizer blends: the stability of the modified PVC materials is studied as a function of time, to determine if phase separation occurs with aging.

Further applications of the present invention. The disclosed methods may be employed for applications well beyond phthalate mimics, and the thermal 1,3-dipolar Huisgen azide-alkyne cycloaddition at ambient temperature in the absence of copper has many important applications that are enabled using the disclosed methods. The surprisingly mild conditions required to effect thermal “click” cycloaddition of alkyl azides and very electron-poor alkynes in the absence of a copper catalyst has been overlooked by the community of synthetic chemists, bioorganic chemists and materials chemists.

From our work it is apparent that a single electron-withdrawing group is sometimes sufficient to effect “thermal” Huisgen cycloaddition at room temperature, but often these reactions require extended reaction times, or give low yields. Thus development of electron-poor alkynes bearing two electron-withdrawing groups ensures easy cycloaddition at ambient temperatures in reliably high yields. Versatility in attaching functionalizable handles allows these alkynes to be utilized for Cu-free “click” reactions for a variety of applications. For this purpose, two highly electron deficient alkynes: ester, acid substituted alkyne 16, and sulfone, acid-substituted alkyne 17 are proposed as general starting points for ambient temperature “thermal” click reactions with alkyl azides.

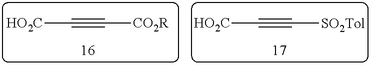

The carboxylic acid can be converted to an amide or ester to allow conjugation of biomolecules, or more generally to alcohol or amine functional groups for a multitude of applications.

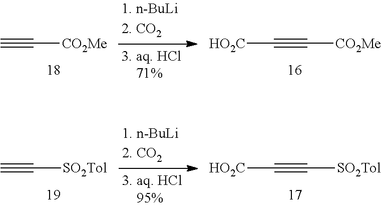

The synthesis of each alkyne is straightforward: Hall has described the synthesis of the methyl ester of 16 starting from commercially available methyl propynoate 18 in 71% yield. Likewise, Corey described the synthesis of sulfone 17 from ptolunesulfonylacetylene 19, in his 1988 synthesis of forskolin.

With these two very electron deficient alkynes, room temperature “click” reactions without copper catalyst can be tested, both as the free carboxylic acids, and as conjugates with a variety of small organic molecules. Reactions in water as well as organic solvents are being investigated. The alkyl group of the ester in alkyne 16 can be manipulated to tune the solubility in water or organic solvents. Using the present disclosure, these methods can be extended to biologically interesting molecules, such as glycopeptides and biomaterial hybrids.

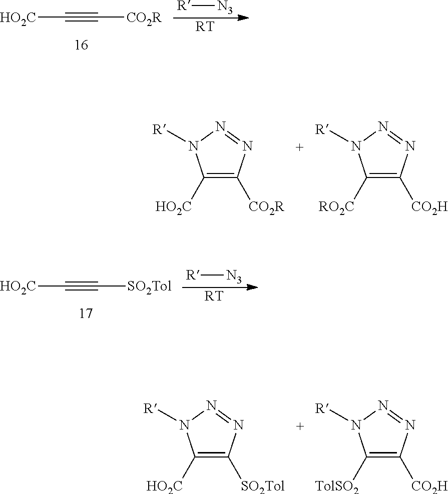

Cycloaddition with alkyl azides provides the expected triazoles at room temperature. The regioselectivity may be determined for small molecules: this regiochemistry may or may not be important for larger molecular assemblies. The thermal stability of these triazoles is high. To date, “unclicking” of 1,2,3-triazoles has only been achieved under mechanical force.

Using the methods of the invention, it is believed that these highly electron deficient alkynes will add to the tool-box of readily available reagents for coupling azides to alkynes under copper-free conditions at room temperature.

In summary, the ‘thermal’ azide-alkyne Huisgen cycloaddition reaction of dialkyl acetylenedicarboxylates with azide-functionalized PVC is carried out to prepare covalently-bonded mimics of phthalate plasticizers to provide effective plasticizers.

This methodology could replace the millions of tons of phthalate esters produced every year. As phthalate esters migrate out of PVC during both the consumer lifetime of commercial products, and for years afterwards as the PVC undergoes degradation, massive amounts of phthalates are introduced into the environment, and become metabolized to form Endocrine Disrupting Chemicals when ingested or absorbed by mammals.

This “click” approach to phthalate mimics provides a simple, economical and scalable alternative.

Equally as important, the development of two versatile electron poor alkynes 16 and 17 for the general application of Cu-free “click” Huisgen cycloaddition at ambient temperature is may be use in organic synthesis, biomolecular investigations and the development of new materials.

1. A method for the production of covalently-bonded mimics of phthalate plasticizers, the method comprising performing an azide-alkyne Huisgen cycloaddition reaction of dialkyl acetylenedicarboxylates with azide-functionalized hydrocarbon polymer.

2. The method of claim 1 wherein thermal azide-alkyne Husigen cycloaddition is performed in the absence of a copper catalyst.

3. The method of claim 1 wherein thermal azide-alkyne Husigen cycloaddition is performed under very mild thermal conditions.

4. The method of claim 3 wherein the thermal conditions are between 5° C. and 30° C. and the time or reaction is at least 4 hours.

5. The method of claim 3 wherein the thermal conditions of the reaction are between 10° C. and 25° C.

6. The method of claim 3 wherein the thermal conditions of the reaction are between 10° C. and 20° C.

7. The method of claim 3 wherein the product of the method is a 1,2,3-triazoles bearing ortho esters.

8. The method of claim 6 wherein the reaction requires at least 4 hours to proceed to at least 80% completion.

9. The method of claim 6 wherein the reaction requires at least 6 hours to proceed to at least 95% completion.

10. The method of claim 1 employing the secondary benzyl chloride 1-chloro-1-phenylethane azide displacement of chloride using NaN₃ on Amberlite resin.

11. The method of claim 1 employing wherein deuterochloroform is used as the solvent.

12. The method of claim 1 wherein geranyl chloride is converted to the corresponding azide.

13. A compound comprising poly vinyl chloride (PVC) and a polyphthalate polymer with a covalent carbon chain backbone having pendant phthalate esters that under environmental conditions do not release phthalate esters, and wherein hydrolysis of the polymer releases only alcohol residues, and does not release phthalate residues, wherein the environmental conditions are as follows: 10 weeks immersed in water at neutral pH at 37° C.

14. The compound of claim 13 wherein the polyphthalate polymer is a polyvinylphthalate ester polymer.

15. The compound of claim 13 wherein the polyphthalate polymer is a copolymer with a comonomer selected from the group consisting of: styrene, substituted styrene derivatives, acrylates, methacrylates, acrylamides, methacrylamides, acrylonitrile, dienes and maleimides.

16. The compound of claim 13 wherein the polyphthalate polymer is poly-(vinylphthalate-co-acrylate).

17. The compound of claim 13 comprising a polymer having a molecular weight of between 2000 and 25000, and a Degree of Polymerization (DP) between 9 and 130.

18. The compound of claim 13 wherein the spacing between pendant phthalate esters is between zero monomers and 200 monomers.

19. A compound of claim 13 wherein no covalent bonds are formed between the plastic and polyphthalate polymer.

20. A method for plasticization of a compound, the method comprising: (a) polymerization of polyphthalate ester monomers to produce a plasticizing polymer with a covalent carbon chain backbone and phthalate ester side-groups wherein hydrolysis of the plasticizing polymer releases only alcohols and does not release phthalates, (b) providing plastic in need a plasticization, (c) mixing the plasticizing polymer and the plastic, wherein the polyphthalate ester monomers are polyvinylphthalate ester monomers and wherein the plastic is poly vinyl chloride (PVC).
